(19) United States
(12) Patent Application Publication
(10) Pub. No.: US 2005/0182952 A1
(43) Pub. Date: Aug. 18, 2005

(54) Information processing apparatus and method and computer program

(75) Inventor: Ikuo Shinozaki, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/048,808

(22) Filed: Feb. 3, 2005

(30) Foreign Application Priority Data
Feb. 12, 2004 (JP) 2004-035475

(51) Int. Cl. G06F 12/00

(52) U.S. Cl. 713/189

(57) ABSTRACT

The present invention provides an information processing apparatus of space-saved type that can execute the processing corresponding to a security function module. A security function module storing a device key is integrally arranged in an MPU chip, the secret data including programs and data to be applied to the data processing to be executed in the security function module are encrypted with the device key or attached with a falsification verification value and the resultant programs and data are stored in an external storage section. This novel configuration can significantly reduce the amount of data to be stored in the security function module and therefore eliminate the necessity for a large-capacity flash memory. Consequently, the security function module can be integrally arranged in the MPU chip having the main CPU, thereby significantly reducing the packaging area and the production cost.

### FIELD OF THE INVENTION

The present invention relates to an information processing apparatus and method and a computer program. More particularly, present invention relates to an information processing apparatus and information processing method and a computer program that, in an information processing apparatus having a security function module for executing secure data processing with secret information such as encryption keys applied, reduce a packaging area of the security function module by setting an area for storing secret information such as encryption keys to external storage section and realize data processing that maintains a sufficient security level.

### BACKGROUND OF THE INVENTION

A secure chip based on the TCPA (Trusted Computing Platform Alliance) protocol is known as a security function module for executing secure data processing by applying secret information such as an encryption key, for example. The TCPA-based secure chip is called a TPM (Trusted Platform Module).

The TPM, built in client computer systems in a computer network, for example, is set as a module that generates a pair of public key and secret key as encryption keys that each client applies on the network and executes such processing of secure data prohibited to be leaked outside as the cryptographic processing of the data applied with these keys.

A specific example of the data processing based on the secure chip includes a configuration in which a boot code as a boot program is stored in a memory inside the secure chip, the boot code is encrypted with the encryption key stored in the secure chip, the encrypted boot code is outputted to the main CPU outside the secure chip and the encrypted boot code is decrypted in the main CPU, thereby executing boot processing, as disclosed in patent document 1, for example. This processing ensures the boot processing by only an authorized boot code.

Recently, it is demanded that TPM be configured also on portable information processing devices and communication terminals to execute data processing of high security level. However, because of various limitations such as the limited hardware mounting area and severe cost-down requirements in portable information processing devices and communication terminals, it is difficult to configure the same TPM as with general personal computers.

Referring to FIG. 1, there is shown a hardware configuration having a general TPM that is set to personal computers, for example.

As shown in FIG. 1, an MPU (Main Processor Unit) chip 10 having a main CPU 11 that executes an OS (Operating System) and application programs and a TPM chip 20 having a TPM 21 that executes secure data processing applied with secret information such as encryption keys are configured as discrete modules. This is because the MPU chip 10 is configured as a chip having a general-purpose processor, while the TPM 21 requires incorporating a non-volatile memory for storing secret information such as encryption keys. This hardware configuration has an external storage device 31 such as a hard disk drive, a main memory 32 made up of RAM and ROM, and an input/output device 33 made up of keyboard, mouse, and display.

If many hardware devices can be installed, as with desktop personal computers, it presents no problem in terms of installation space to install the MPU chip 10 having the main CPU 11 and the TPM chip 20 having the TPM 21 as discrete chips; however, as described above, the installation of the two discrete chips on small-size devices such as portable devices presents problems of hampering device down-sizing and pushing up production cost.

[Patent Document 1] U.S. Pat. No. 5,937,063

### SUMMARY OF THE INVENTION

It is therefore an object of the present invention to provide an information processing apparatus and method and a computer program that are intended to reduce the packaging area for a security function module by setting an area for storing secret information such as encryption keys to external storage section in the information processing apparatus having the security function module for executing the processing of data applied with the secret information such as encryption keys and, at the same time, realize the data processing that maintains sufficient security level.

In carrying out the invention and according to a first aspect thereof, there is provided an information processing apparatus including: a main processor unit (MPU) chip accommodating a processor for executing a data processing program; and an external storage section connected to the MPU chip; wherein the MPU chip accommodates a main Central processing unit (CPU) and a security function module for executing data processing requiring security; and the security function module holds a device key to be applied to cryptographic processing, stores secret information including one of a program and data to be applied to data processing to be executed in the security function module into the external storage section as data encrypted with the device key, decrypts the encrypted secret information stored in the external storage section with the device key, and executes data processing requiring security by applying one of the program and data obtained by the decryption processing.

In the above-mentioned information processing apparatus, preferably, the security function module sets a falsification verification value to secret information including one of a program and data to be applied to data processing to be executed in the security function module, stores the resultant secret information into the external storage section, verifies the secret information stored in the external storage section for no data falsification, and, if one of the program and the data is found free of data falsification, executes data processing requiring security by applying one of the program and the data. It should be noted that the falsification verification is executed by keyed message authenticating, the device key is applied. In accordance with the security level, the device key to be applied here may be the same as that used for encryption or a different one designed for falsification verification.

In the above-mentioned information processing apparatus, the external storage section stores at least one of a part of a boot code of the main CPU as data encrypted with the device key; and the security function module decrypts the boot code obtained from the external storage section and executes boot processing of the main CPU on the basis of the decrypted boot code.

In the above-mentioned information processing apparatus, the device key is data written to one of a fuse ROM (Read Only Memory) called an e-fuse, a mask ROM, both being arranged in the MPU chip, and a non-volatile memory chip stacked on the MPU chip.

In carrying out the invention and according to a second aspect thereof, there is provided an information processing apparatus including: a main processor unit (MPU) chip accommodating a processor for executing a data processing program; and external storage section connected to the MPU chip; wherein the MPU chip accommodates an MPU having a processor for executing data processing and a device key to be applied to cryptographic processing; the MPU operates in two modes; a normal mode in which an operation program is executed on a normal OS (Operating System) and a secure mode in which a secure program corresponding to data processing requiring security is executed; and the MPU stores secret information including one of a program and data to be executed in the secure mode into the external storage section as data encrypted with the device key, decrypts the encrypted secret information stored in the external storage section with the device key, and executes the secure program by applying one of the decrypted program and the decrypted data.

In the above-mentioned information processing apparatus, the MPU sets a falsification verification value to secret information including one of a program and data to be executed in the secure mode, stores the resultant secret information into the external storage section, verifies the secret information stored in the external storage section for data falsification, and, if one of the program and the data is found free of data falsification, executes the secure program by applying one of the program and the data.

In the above-mentioned information processing apparatus, the external storage section stores at least a part of a boot code of a normal OS (Operating System) corresponding to the normal mode as data encrypted with the device key; and the MPU decrypts the boot code obtained from the external storage section in accordance with the secure program and, on the basis of the decrypted boot code, executes boot processing of the normal OS.

In the above-mentioned information processing apparatus, preferably, the device key is data written to one of a fuse ROM (Read Only Memory) called an e-fuse, a mask ROM, both being arranged in the MPU chip, and a non-volatile memory chip stacked on the MPU chip.

In carrying out the invention and according to a third aspect thereof, there is provided an information processing method including the steps of: obtaining encrypted secret information including one of a program and data to be applied to data processing to be executed in a security function module from an external storage section; decrypting the encrypted secret information by applying a device key stored in the security function module; verifying the decrypted secret information for data falsification; and executing data processing by applying one of the program and the data included in the secret information found free of data falsification.

The above-mentioned information processing method further including the step of: storing the secret information including one of a program and data to be applied to data processing to be executed in the security function module into the external storage section as data encrypted with the device key.

The above-mentioned information processing method still further including the step of: setting a falsification verification value to the secret information including one of a program and data to be applied to data processing to be executed in the security function module and storing the secret information into the external storage section.

The above-mentioned information processing method yet further including the step of: decrypting a boot code obtained from the external storage section and executing boot processing on the basis of the encrypted boot code obtained by decrypting.

In carrying out the invention and according to yet another aspect thereof, there is provided a computer program for executing information processing, including the steps of: obtaining encrypted secret information including one of a program and data to be applied to data processing to be executed in a security function module from an external storage section; decrypting the encrypted secret information by applying a device key stored in the security function module; verifying the decrypted secret information for data falsification; and executing data processing by applying one of the program and the data included in the secret information found free of data falsification.

It should be noted that the computer program according to the present invention can be provided to computer systems on which various program codes are executable, in the form of a computer-readable form and stored in recording media such as CDs, FDs, and MOs or communication media such as network. The computer-readable provision of the program realizes the above-mentioned processing according to the invention on each computer system provided with this program.

Many other features, advantages, and additional objects of the present invention will become manifest to those versed in the art upon making reference to the detailed description which follows and the accompanying sheet of drawings. It should also be noted that a term “system” as used herein denotes a logical aggregate of a plurality of component units and these component units are not always accommodated in a same housing.

As described above and according, a security function module storing a device key is integrally arranged in an MPU chip, the secret data including programs and data to be applied to the data processing to be executed in the security function module are encrypted with the device key or attached with a falsification verification value and the resultant programs and data are stored in an external storage section. This novel configuration can significantly reduce the amount of data to be stored in the security function module and therefore eliminate the necessity for a large-capacity non-volatile memory. This, in turn, allows the security function module to be integrally arranged in an MPU having a main CPU, thereby significantly saving the packing area and the production cost. In addition, the secret information to be recorded to an external storage section is encrypted with the device key or attached with a falsification verification value, thereby realizing the data processing with highly enough security level.

Further, as described above, another novel configuration is provided in which a processor for executing data processing and a device key to be applied to cryptographic processing are arranged in an MPU chip and two modes are provided; a normal mode in which operation programs are executed on the normal OS and a secure mode in which secure programs corresponding to the data processing for which security is required. The secret information including programs or data to be executed in the secure mode is encrypted with a device key or attached with a falsification verification value and the resultant programs or data are stored in an external storage section. This novel configuration eliminates the necessity for having the security function module as the hardware of a separate configuration, thereby significantly saving the packaging area and the production cost. In addition, the secret information to be recorded to an external storage section is encrypted with the device key or attached with a falsification verification value, thereby realizing the data processing with highly enough security level.

The above-mentioned sequence of processing operations may be executed by software as well as hardware. When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

For example, the programs can be recorded to recording media such as a hard disk unit and a ROM in advance. Alternatively, the programs can be temporarily or permanently stored (or recorded) to removable recording media such as a flexible disk, a CD-ROM (Compact Disc Read Only Memory), an MO (Magneto-Optical) disk, a DVD (Digital Versatile Disc), a magnetic disk, and a semiconductor memory. These removable recording media can be provided as so-called package software.

It should be noted that, in addition to installing from the above-mentioned removable recording media into the computer, the programs may be downloaded from download sites in a wireless manner or in a wired manner via a network such as the Internet or LAN (Local Area Network) into the computer, in which the downloaded programs are installed in its hard disk drive or other recording devices.

It should be noted herein that the processing operations described herein include not only the processing operations that are sequentially executed in time-series but also the processing operations that are executed concurrently or discretely. It should also be noted that term “system” as used herein denotes an entire apparatus configured by a plurality of component units.

As described and according to the invention, a security function module storing a device key is integrally arranged in an MPU chip, the secret data including programs and data to be applied to the data processing to be executed in the security function module are encrypted with the device key or attached with a falsification verification value and the resultant programs and data are stored in an external storage device. This novel configuration can significantly reduce the amount of data to be stored in the security function module and therefore eliminate the necessity for a large-capacity non-volatile memory. This, in turn, allows the security function module to be integrally arranged in an MPU having a main CPU, thereby significantly saving the packing area and the production cost. In addition, the secret information to be recorded to an external storage device is encrypted with the device key or attached with a falsification verification value, thereby realizing the data processing with highly enough security level.

Further, according to the present invention, another novel configuration is provided in which a processor for executing data processing and a device key to be applied to cryptographic processing are arranged in an MPU chip and two modes are provided; a normal mode in which operation programs are executed on the normal OS and a secure mode in which secure programs corresponding to the data processing for which security is required. The secret information including programs or data to be executed in the secure mode is encrypted with a device key or attached with a falsification verification value and the resultant programs or data are stored in an external storage device. This novel configuration eliminates the necessity for having the security function module as the hardware of a separate configuration, thereby significantly saving the packaging area and the production cost. In addition, the secret information to be recorded to an external storage device is encrypted with the device key or attached with a falsification verification value, thereby realizing the data processing with highly enough security level.

### BRIEF DESCRIPTION OF THE DRAWINGS

FIG. 1 is a block diagram illustrating an exemplary configuration of an information processing apparatus having a TPM module;

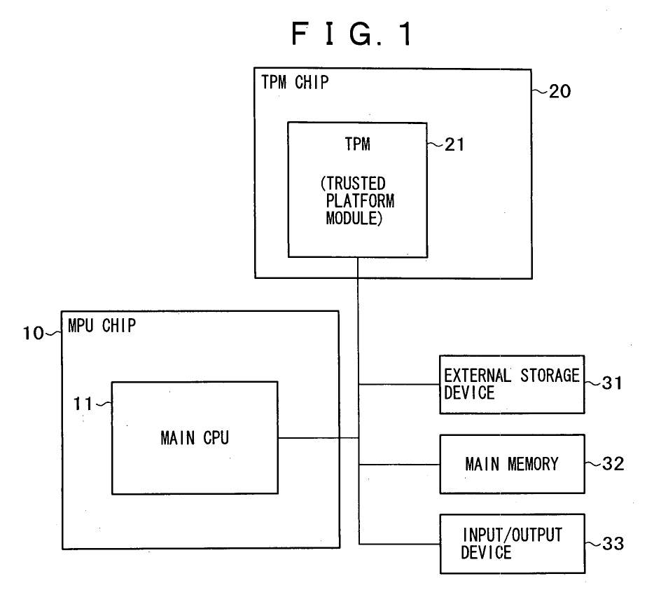

FIG. 2 is a block diagram illustrating an exemplary configuration of an information processing apparatus having a security function module (TPM-E), practiced as a first embodiment of the invention;

FIG. 3 is a block diagram illustrating a detail configuration of the security function module (TPM-E) shown in FIG. 2;

FIG. 4 is a flowchart indicative of a boot processing sequence of the information processing apparatus having the security function module (TPM-E) shown in FIG. 2;

FIG. 5 is a block diagram illustrating an exemplary configuration of an information processing apparatus practiced as a second embodiment of the invention;

FIG. 6 is a schematic diagram illustrating an exemplary software configuration of the information processing apparatus shown in FIG. 5; and

FIG. 7 is a flowchart indicative of a boot processing sequence of the information processing apparatus shown in FIG. 5.

### DESCRIPTION OF THE PREFERRED EMBODIMENTS

The following describes details of an information processing apparatus and method and a computer program with reference to the drawings appended hereto.

### First Embodiment

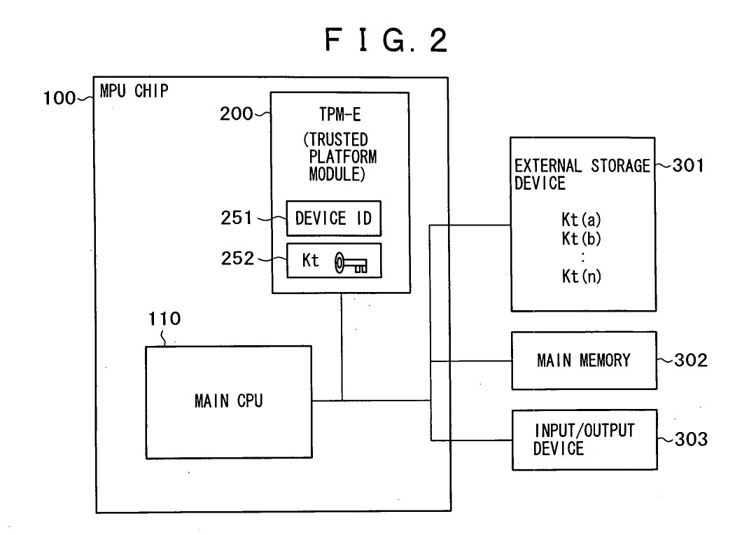

Now, referring to FIG. 2, there is shown an exemplary hardware configuration of an information processing apparatus practiced as a first embodiment of the invention.

The hardware of the information processing apparatus practiced as the first embodiment of the invention has a configuration in which a main CPU 110 for executing the OS and application programs and a security function module 200 based on TPM (Trusted Platform Module) or the like for executing the secure data processing applied with secret information such as encryption keys are accommodated in a main processor unit (MPU) chip 100 as a single chip. This information processing apparatus also has an external storage device 301 based on flash memory or hard disk drive or the like, a main memory 302 based on a RAM and a ROM or the like, and an input/output device 303 based on a keyboard, a mouse, and a display, for example.

Unlike the conventional TPM, the security function module 200 accommodated in the MPU chip 100 has no large-capacity non-volatile memory for storing secret information such as encryption keys inside the module. To make distinction from the conventional TPM, the TPM configured in the MPU chip associated with the first embodiment of the present invention is denoted a TPM-E (Trusted Platform Module for Embedded systems).

The security function module 200 (TPM-E) accommodated in the MPU chip 100 executes the secure data processing applied with secret information such as encryption keys. However, in the information processing apparatus according to the present invention, the secret information such as encryption keys is stored in the external storage device 301 based on a flash memory or a hard disk drive.

The secret information such as encryption keys to be in the external storage device 301 is encrypted with a device key Kt 252 stored in the security function module (TPM-E) 200. The security function module (TPM-E) 200 stores a device ID 251 and the device key Kt 252. The external storage device 301 shown in FIG. 2 stores data Kt(a), Kt(b) through Kt(n) that are encrypted with the device key Kt 252, for example. It should be noted that Kt(x) denotes the data that is obtained by encrypting secret information x with device key Kt 252.

Related-art configurations require configuring a non-volatile memory of comparatively large capacity in the TPM to store all various secret information such as encryption keys a, b, c trough n. However, the security function module (TPM-E) 200 according to the present embodiment has no large-capacity non-volatile memory for storing these many pieces of secret information.

In the present embodiment, these many pieces of secret information are stored in the external storage device 301 and the device key Kt 252 is stored in the security function module (TPM-E) 200. The device key Kt 252 is accessible only in the security function module (TPM-E) 200 and inaccessible by the main CPU 110, so that the device key Kt 252 never be outputted outside the module.

The device key Kt 252 is written as a fixed data corresponding to the security function module (TPM-E) 200, as e-fuse (fuse ROM) data or mask ROM data for example, at the time of manufacturing the MPU chip 100. Namely, the device key Kt 252 is written as a non-rewritable fixed data. Alternatively, a configuration may be used in which non-volatile memories such as comparatively small capacity flash memories or FeRAMs are stacked as a multi-package or a system-in package.

It should be noted that the device key Kt 252 may also be set as different key data for different MPU chips or as key data common to a plurality of chips on a manufacture lot basis, for example.

The device key Kt 252 to be held in the security function module (TPM-E) 200 is an encryption key that is applied to the encryption and decryption of each piece of secret information stored in the external storage device 301 shown in FIG. 2 and is set as the key data having a data length corresponding to a security level required for a device, namely the information processing apparatus having the MPU chip 100.

The external storage device 301 shown in FIG. 2 stores data Kt(a), Kt(b), through Kt(n) encrypted with the device key Kt 252, for example. The data to be encrypted with the device key Kt 252 is various items of data that require security, including various types of program codes, encryption keys, passwords, and other code data and contents.

The security function module (TPM-E) 200 executes the data processing that follows, for example:
(1) encryption processing to be executed by applying the device key Kt 252 for storing secret information a, b, c through n into the external storage device 301;
(2) decryption processing to decrypt encrypted secret information Kt(a), Kt(b), Kt(c) through Kt(n) read from the external storage device 301; and
(3) processing of generating new keys, executing authentication, and verifying data falsification.

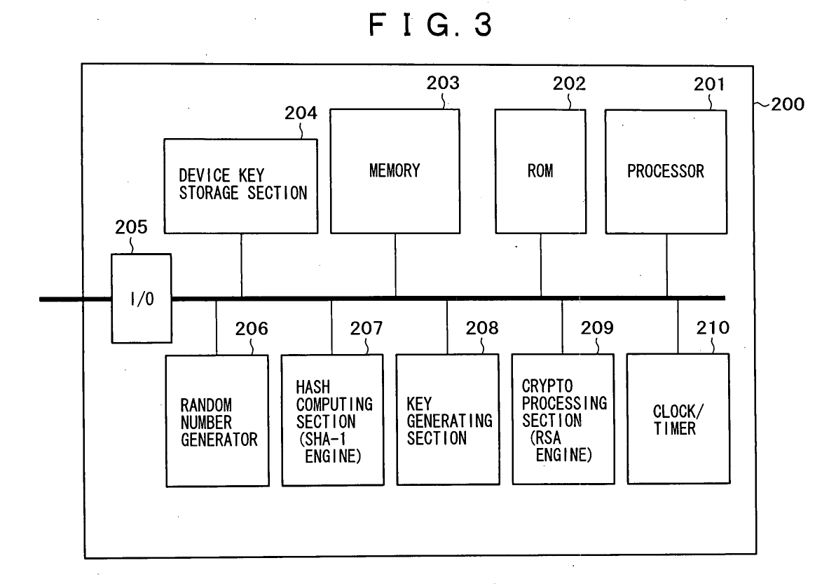

FIG. 3 shows a detail configuration of the security function module (TPM-E) 200. As shown, the security function module (TPM-E) 200 has a processor 201, a ROM 202, a memory 203, a device key storage section 204, an input/output (I/O) interface 205, a random number generator 206, a hash computing section 207, a key generating section 208, a cryptographic processing section 209, and a clock/timer 210 which are interconnected by a bus.

The processor 201 controls the execution of the program associated with the secure data processing that is executed in the security function module (TPM-E) 200. The processor 201 also controls the data processing in each component of the security function module (TPM-E) 200 and the data input/output processing that is executed through the bus and the input/output (I/O) interface 205.

The ROM 202 and the memory 203 provide areas in which the programs and computation parameters to be used by the processor 201 and the data read from the external storage device 301 are stored.

The ROM 202 stores at least a part of the boot processing program for the security function module (TPM-E) 200, a TPM-E control program which is a data processing program that is executed in the security function module (TPM-E) 200, and key information. These programs and information are written as mask ROM data, for example. The detail of the boot processing sequence by the boot processing program written to the ROM 202 will be described later.

The program data constituting the TPM-E control program, other programs requiring secrecy, and the data such as encryption keys may be stored in the ROM 202; but, if they are not stored in the ROM 202, they are stored in the external storage device 301 as the encrypted data with device key Kt applied. For example, the following data are stored in the external storage device 301 as encrypted data:
(a) program data constituting the TPM-E control program;
(b) the boot program (or the main CPU boot code) that is executed by the main CPU;
(c) endorsement keys based on public key cryptography, for example;
(d) credentials; and
(e) TPM-E internal status initial value.

These pieces of data are stored in the ROM 202 or the external storage device 301 as the encrypted data applied with device key Kt. It should be noted that the program to be executed by the main CPU is hereafter referred to as CRTM (Code Root of Trust for Measurement).

As described above, the device key storage section 204 holds the device key data written as e-fuse data or mask ROM data. If the above-mentioned program or data (a) through (e) are stored in the external storage device 301, these programs or data are encrypted by applying device key Kt in the cryptographic processing section 209 in the security function module (TPM-E) 200 and the encrypted programs or data are outputted via the input/output (I/O) interface 205 to be stored in the external storage device 301. As required, a value for verifying the falsification of the stored data is generated in the hash computing section 207 and stored in the external storage device 301 along with the encrypted program or data.

When the above-mentioned program or data (a) through (e) are used by inputting from the external storage device 301, the encrypted data is decrypted in the security function module (TPM-E) 200 and the falsification verification value is verified that there is no falsification in the data or program, after which the program is executed or the data is used. It should be noted that the falsification verification is executed by keyed message authenticating, the device key is applied. In accordance with the security level, the device key to be applied here may be the same as that used for encryption or a different one designed for falsification verification.

It should be noted that the program or data encrypted with the device key is stored in one of the external storage devices 301, in the example shown in FIG. 2; the encrypted program or data may alternatively be stored in a plurality of external storage devices in a distributed manner or multiplexed manner for higher security. Desirably, the encrypted data is set as a protected data area in terms of hardware or software such that it is accessible only by means of commands issued from the processor 201 in the security function module (TPM-E) 200 and inaccessible by the main CPU 110 (refer to FIG. 2).

The data indicative of the correlation between the device ID unique to the security function module (TPM-E) 200 and the device key stored in the security function module (TPM-E) 200 is held in a trusted center.

The input/output (I/O) interface 205 executes a data input/output operation with components sections outside the security function module (TPM-E) 200.

The random number generator 206 executes the processing of generating random numbers necessary for the generation of encryption keys and falsification verification values, for example. The hash computing section 207 executes a hash computation that is applied to the generation of data falsification verification value, for example. For the hash algorithm used in the present embodiment, SHA-1 is applied, for example. It should be noted that, for the falsification verification value, MAC (Message Authentication Code) is applied, for example.

The key generating section 208 executes the processing of generating encryption keys in the security function module (TPM-E) 200. For example, the DES or AES cryptographic algorithm is applied to this processing. The cryptographic processing section 209 executes data encryption and decryption processing. For example, the cryptographic processing section 209 executes encryption and decryption processing by use of the key stored in the device key storage section 204, in accordance with the DES or AES cryptographic algorithm, for example. The clock/timer 210 executes the provision of time and clock information in the security function module (TPM-E) 200.

The security function module (TPM-E) 200 having the above-mentioned configuration is arranged in the MPU chip 100 as shown in FIG. 2.

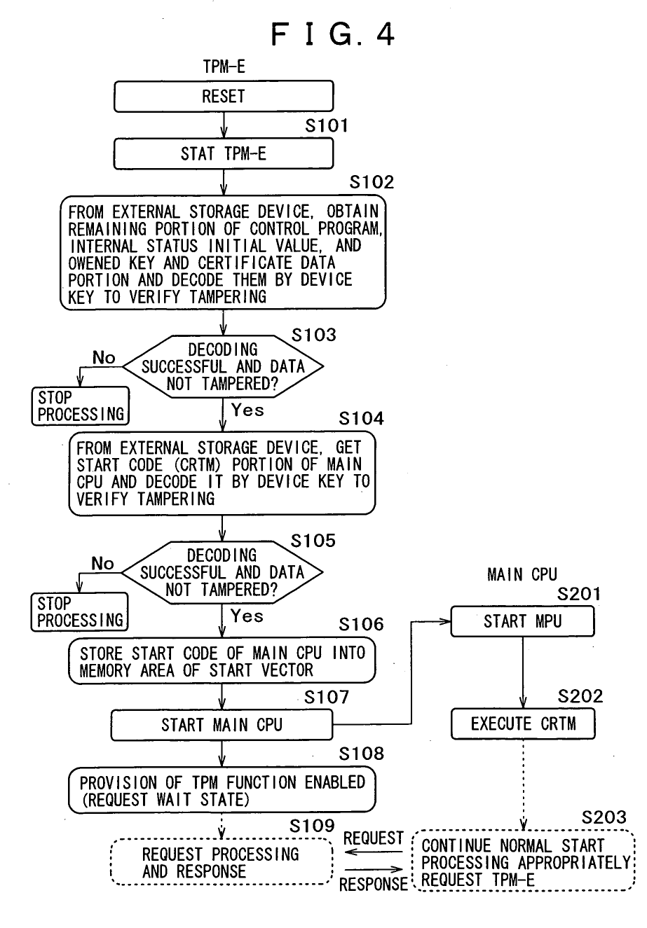

The following describes the boot processing sequence of the information processing apparatus according to the first embodiment with reference to FIG. 4.

The boot processing sequence shown in FIG. 4 is executed at the time of so-called power-on reset (POR), such as the power-on or reset of the information processing apparatus. Steps S101 through S109 shown at the left of FIG. 4 are executed by the security function module (TPM-E) 200 and steps S201 through S203 shown at the right are executed by the main CPU 110.

First, in step S101, the security function module (TPM-E) 200 is started up before the main CPU 110 starts its execution. The processor 201 (refer to FIG. 3) in the security function module (TPM-E) 200 executes the control program for boot execution stored in the ROM 202 of the security function module (TPM-E) 200.

In step S102, in accordance with this control program, data is read from the external storage device 301 (refer to FIG. 2) to be decrypted and verified for falsification. The read data is once stored in the security function module (TPM-E) 200. The data read includes the following, for example:
program data constituting the TPM-E control program;
an encryption key, an endorsement key based on a public key cryptography, for example;
credential; and
TPM-E internal status initial value.

All of the above-mentioned data are encrypted with the device key Kt. The cryptographic processing section 209 of the security function module (TPM-E) 200 decrypts these pieces of data by applying the device key Kt stored in the device key storage section 204. Further, if the obtained data is attached with the falsification verification value, MAC or the like, the computation of MAC is executed to match the computed MAC with the attached MAC, thereby determining the data for falsification.

If the data obtained from the external storage device 301 is found successfully decrypted and to be free from any data falsification in step S103, then the procedure goes to step S104. If the data decryption is found failed or the data is found falsified, then the processing is discontinued without going to step S104.

In step S104, the boot code (CRTM: main CPU boot code) of the main CPU 110 is obtained from the external storage device 301 to be decrypted and verified for falsification. The cryptographic processing section 209 of the security function module (TPM-E) 200 decrypts the boot code of the main CPU 110 by applying the device key Kt stored in the device key storage section 204. Further, if the obtained data is attached with the falsification verification value, MAC or the like, the computation of MAC is executed to match the computed MAC with the attached MAC, thereby determining the data for falsification.

If the boot code of the main CPU 110 obtained from the external storage device 301 is found successfully decrypted and to be free from any data falsification in step S105, then the procedure goes to step S106. If the data decryption is found failed or the data is found falsified, then the processing is discontinued without going to step S106.

In step S106, the boot code of the main CPU 110 obtained from the external storage device 301 and decrypted in step S104 is stored in a memory area specified by a boot vector. The boot vector has the start address information of the memory area in which the boot code is stored. In step S107, the boot code is read from the memory area specified by the boot vector, thereby executing the boot processing of the main CPU.

When the above-mentioned processing has completed, in step S108, the security function module (TPM-E) 200 enters the state in which to wait for a processing request from the outside, namely, from the main CPU 110. In step S109, the security function module (TPM-E) 200 executes the processing in accordance with the request from the main CPU 110.

On the other hand, the main CPU 110 is booted on the basis of the boot code of the main CPU 110 in step S201. In step S202, the main CPU 110 executes the processing in accordance with the boot code. In step S203, the main CPU 110 executes the data processing in accordance with various execution programs. If the processing to be executed by the security function module (TPM-E) 200 occurs in this data processing, the main CPU 110 requests the security function module (TPM-E) 200 for executing the processing. In step S109, the security function module (TPM-E) 200 executes the processing requested by the main CPU 110.

In the above-mentioned sequence, the boot code of the main CPU 110 is encrypted by the device key Kt and the encrypted boot code is stored in the external storage device 301. If the boot code has no confidentiality, it need not be encrypted. If there is no need for falsification verification, the falsification verification value need not be attached.

The following describes the processing of updating the data encrypted by use of the device key Kt and stored in the external storage device 301. The endorsement key and the setting information including TPM-E internal status initial value, owner authentication secrete (or password), falsification verification processing algorithm are sometimes on a temporary basis and therefore need to be updated from time to time.

In the related-art security function module (TPM), all of the above-mentioned key and information are stored in a non-volatile memory inside the module and they can be updated as the processing only inside the module. However, with the security function module (TPM-E) 200 according to the present invention, at least a part of these key and information is stored in the external storage device 301, so that the data update processing cannot be executed inside the security function module alone.

Therefore, in updating the data stored in the external storage device 301, the security function module (TPM-E) 200 caches the update data obtained from the outside or generated inside the security function module (TPM-E) 200 into the memory 203 of the security function module (TPM-E) 200, computes the falsification verification value, MAC or the like, for the cached update data to set the falsification verification value, and encrypts the update data by applying the device key Kt, thereby storing the encrypted update data into the external storage device 301 via the input/output (I/O) interface 205.

### Second Embodiment

With the above-mentioned first embodiment, the configuration has been described in which the security function module (TPM-E) is arranged in the MPU chip having the main CPU. The following describes a configuration in which a privilege mode OS different from the normal application OS executed by the MPU is used, thereby executing the security function module (TPM) in the privilege mode.

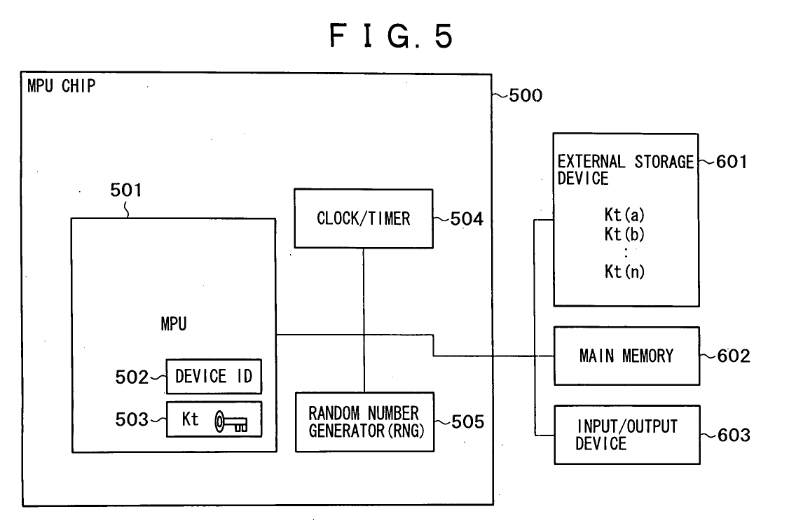

Referring to FIG. 5, there is shown a hardware configuration of an information processing apparatus practiced as the second embodiment of the invention. As shown in FIG. 5, the information processing apparatus according to the second embodiment has no security function module (TPM) as hardware, which is explained in the first embodiment.

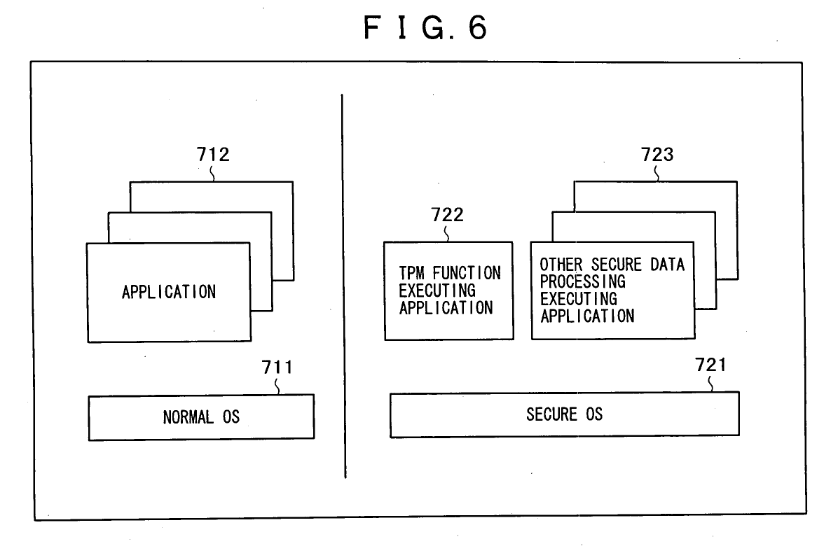

All programs including the secure data processing executed in the security function module (TPM) are executed by a MPU 501. However, as will be described later, unlike the normal OS that provides an execution environment of normal application programs, the processing programs in accordance with the security function module (TPM) are set so as to operate on the secure OS in the privilege mode presiding over the normal OS. A configuration of these processing programs will be detailed later with reference to FIG. 6.

First, the hardware configuration shown in FIG. 5 will be described. The hardware of the information processing apparatus practiced as the second embodiment of the invention has a MPU chip 500 in which the MPU 501 is accommodated, an external storage device 601 based on a flash memory or a hard disk drive or the like, a main memory 602 based on a RAM and a ROM or the like, and an input/output device 603 based on a keyboard, a mouse, and a display or the like.

The MPU 501 has a processor capability of allowing the processing in the above-mentioned privilege mode. This MPU may be realized by Intel La Grade or ARM Trust Zone, for example.

The MPU chip 500 in which the MPU 501 is accommodated also incorporates a clock/timer 504 and a random number generator 505. The ROM area in the MPU 501 stores device ID 502 and device key Kt 503. A device ID 502 and a device key Kt 503 are set as a unique ID and a unique key that is different from each MPU chips 500 or a value and key data that are different from each manufacture lots.

Access to the device ID 502 and the device key Kt 503 from the outside of the MPU chip 500 is disabled. These device ID 502 and device key Kt 503 are accessible only by the processing programs that are compliant with the security function module (TPM), a program that operates on the secure OS in the privilege mode executable in the MPU 501. It should be noted that the ROM in the MPU 501 stores a part of programs to be executed in the boot sequence and the boot vector including the address information of programs to be obtained from the external storage device 601.

The random number generator 505 generates random numbers necessary for generating encryption keys and falsification verification values. The clock/timer 504 provides clock and time information in the MPU 501.

Like the information processing apparatus according to the first embodiment, the information processing apparatus according to the second embodiment stores the secret information such as encryption keys, namely the data shown below, into the external storage device 601 based on a flash memory or a hard disk drive.

(a) program data constituting the TPM control function execution program;
(b) the secure OS program;
(c) the boot program for a normal OS (or the main CPU boot code) that is executed by the CPU;
(d) endorsement keys based on a public key cryptography, for example;
(e) credentials; and
(f) TPM control function execution program initial value.

As with the first embodiment, the above-mentioned pieces of information to be stored in the external storage device 601 are attached with falsification verification values such as MAC (Message Authentication Code) as required and stored as data encrypted by device key Kt 503 stored in the MPU chip 500. The external storage device 601 shown in FIG. 6 stores data Kt(a), Kt(b) through Kt(n) encrypted by the device ID 502, for example. It should be noted that Kt(x) denotes data obtained by encrypting secret information x with device key Kt 503.

The configuration of the second embodiment also has no large-capacity non-volatile memory for storing many pieces of secret information in the MPU chip 500. The data stored in the flash memory in the TPM in the related-art security function module (TPM) are encrypted and stored in the external storage device 601.

As with the first embodiment, the device key Kt 503 is recorded as a fixed data at manufacture of the MPU chip 500; for example, as e-fuse (fuse ROM) data or mask ROM data or data recorded to non-volatile memories such as comparatively small capacity flash memories or FeRAMs stacked as a multi-package or a system-in package.

This device key Kt 503 is applied to encrypt and decrypt the various pieces of secret information to be stored in the external storage device 601 and is set as key data having a data length in accordance with a security level required for the device, namely, the information processing apparatus on which the MPU chip 500 is installed.

The following describes a program configuration of the information processing apparatus according to the second embodiment. The programs to be executed in the information processing apparatus according to the second embodiment are executed under the control of the MPU 501 in the MPU chip 500. These execution programs also include execution programs that are compliant with the related-art security function module (TPM).

As shown in FIG. 6, in the information processing apparatus according to the second embodiment, a normal application 712 that is a normal data processing program is executably set on a normal OS 711 that is a normal operating system. This is generally the same as general PCs or the like.

In the configuration of the present invention, a secure OS 721 is set as a privilege mode OS that is higher than the normal OS 711. It should be noted that an OS known as the secure OS 721 is Nexus of Microsoft NGSCB, for example.

A TPM function execution application program 722 is executable only on the secure OS 721, and therefore cannot be executed in the environment of the normal OS 711.

The TPM function execution application program 722 executes generally the same processing as the security function module (TPM-E) of the first embodiment, namely:
(1) encryption processing to be executed by applying the device key Kt 503 for storing secret information a, b, c through n into the external storage device 601;
(2) decryption processing to decrypt encrypted secret information Kt(a), Kt(b), Kt(c) through Kt(n) read from the external storage device 601; and
(3) processing of generating new keys, executing authentication, and verifying data falsification.

The TPM function execution application program 722 provides various TPM functions, for example, secure data processing functions such as bind processing and seal processing, to the normal OS 711 and the normal application 712 and drivers that operate on the normal OS 711.

It should be noted that the programs that are executable on the secure OS 721 include not only the TPM function execution application program 722 but also a secure data processing execution application 723.

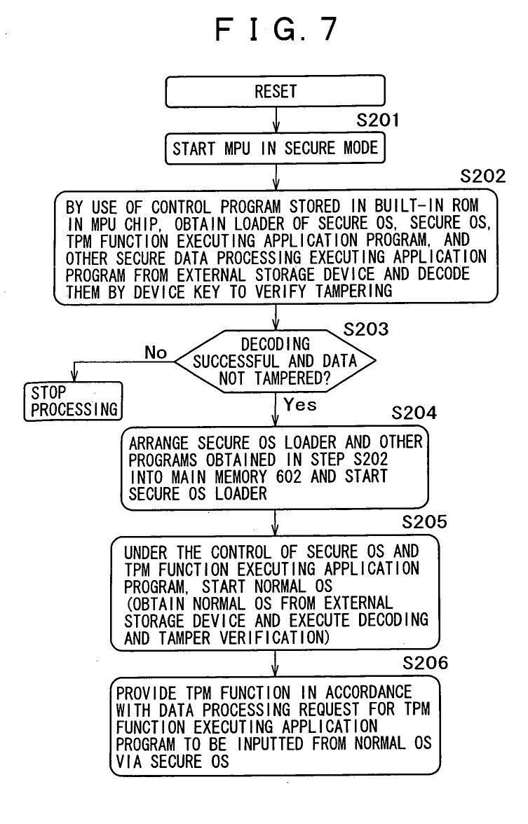

The following describes a boot processing sequence of the information processing apparatus according to the second embodiment with reference to FIG. 7.

The boot processing sequence shown in FIG. 7 is executed at the time of so-called power-on reset (POR), such as the power-on or reset of the information processing apparatus. First, in step S201, the MPU 501 is started up in the secure mode.

In step S202, the control program stored in the ROM in the MPU chip obtains the secure OS, the TPM function execution application program 722, and the secure data processing execution application 723 from the external storage device 601. It should be noted that the programs other than the secure OS loader may be obtained, decrypted, and verified after the execution of the secure OS loader in step S204.

In step S202, the above-mentioned data obtained from the external storage device 601 are also decrypted and verified for falsification. These obtained data are all encrypted with device key Kt and therefore decrypted with device key Kt 503. In addition, if the obtained data is attached with a falsification verification value, MAC for example, MAC is computed and the computed MAC is matched with the attached MAC to check for any data falsification.

If, in step S203, the decryption of the data obtained from the external storage device 601 is found successful and therefore the data is found free of falsification, then the procedure goes to step S204. If the decryption of the data is found failed or the data is found falsified, then the processing is stopped without going to step S204.

In step S204, the decrypted and verified secure OS loader and programs obtained in sep S202 are arranged in the main memory 602. Next, the secure OS loader is started up. If the secure OS has not been obtained in step S202, the started secure OS loader obtains the secure OS from the external storage device and decrypts, and verifies the obtained secure OS, and stores the secure OS into the main memory. Then, the secure OS loader starts up the secure OS. Likewise, the secure OS starts up the TPM function execution application program and other secure data processing execution applications. In step S205, under the control of the secure OS and the TPM function execution application program, the normal OS is started up. It should be noted that this processing includes the reading of the normal OS from the external storage device 601, the decryption of the obtained data with device ID 502, and, if the obtained data is attached with a falsification verification value, MAC or the like, the computation of MAC to check the data for falsification.

If the decryption of the data is found failed or the data is found falsified, then the processing is stopped without starting up the normal OS.

If the decryption of the data is found successful and the data is found free from falsification, then the normal OS is started up, upon which the procedure goes to step S206, thereby providing the TPM function in response to a data processing request to the TPM function execution application program entered from the normal OS via the secure OS.

While the above-mentioned preferred embodiments of the present invention have been described using specific terms, such description is for illustrative purpose only, and it is to be understood that changes and variations may be made without departing from the spirit or scope of the following claims.

1. An information processing apparatus comprising:
a main processor unit (MPU) chip accommodating a processor for executing a data processing program; and
an external storage section connected to said MPU chip;
wherein
said MPU chip accommodates a main central processing unit (CPU) and a security function module for executing data processing requiring security; and
said security function module holds a device key to be applied to cryptographic processing, stores secret information including one of a program and data to be applied to data processing to be executed in said security function module into said external storage section as data encrypted with said device key, decrypts the encrypted secret information stored in said external storage section with said device key, and executes data processing requiring security by applying one of the program and data obtained by the decryption processing.

2. The information processing apparatus according to claim 1, wherein said security function module sets a falsification verification value to secret information including one of a program and data to be applied to data processing to be executed in said security function module, stores the resultant secret information into said external storage section, verifies said secret information stored in said external storage section for no data falsification, and, if one of said program and said data is found free of data falsification, executes data processing requiring security by applying one of said program and said data.

3. The information processing apparatus according to claim 1, wherein said external storage section stores at least one of a part of a boot code of said main CPU as data encrypted with said device key; and
said security function module decrypts said boot code obtained from said external storage section and executes boot processing of said main CPU on the basis of the decrypted boot code.

4. The information processing apparatus according to claim 1, wherein said device key is data written to one of a fuse read only memory (ROM) called an e-fuse, a mask ROM, both being arranged in said MPU chip, and a non-volatile memory chip stacked on said MPU chip.

5. An information processing apparatus comprising:
a main processor unit (MPU) chip accommodating a processor for executing a data processing program; and
an external storage section connected to said MPU chip;
wherein said MPU chip accommodates an MPU having a processor for executing data processing and a device key to be applied to cryptographic processing;
said MPU operates in two modes; a normal mode in which an operation program is executed on a normal OS (Operating System) and a secure mode in which a secure program corresponding to data processing requiring security is executed; and
said MPU stores secret information including one of a program and data to be executed in said secure mode into said external storage section as data encrypted with said device key, decrypts the encrypted secret information stored in said external storage section with said device key, and executes said secure program by applying one of the decrypted program and the decrypted data.

6. The information processing apparatus according to claim 5, wherein said MPU sets a falsification verification value to secret information including one of a program and data to be executed in said secure mode, stores the resultant secret information into said external storage section, verifies said secret information stored in said external storage section for data falsification, and, if one of said program and said data is found free of data falsification, executes said secure program by applying one of said program and said data.

7. The information processing apparatus according to claim 5, wherein said external storage section stores at least a part of a boot code of a normal operating system (OS) corresponding to said normal mode as data encrypted with said device key; and
said MPU decrypts said boot code obtained from said external storage section in accordance with said secure program and, on the basis of the decrypted boot code, executes boot processing of said normal OS.

8. The information processing apparatus according to claim 5, wherein said device key is data written to one of a fuse ROM (Read Only Memory) called an e-fuse, a mask ROM, both being arranged in said MPU chip, and a non-volatile memory chip stacked on said MPU chip.

9. An information processing method comprising the steps of:
obtaining encrypted secret information including one of a program and data to be applied to data processing to be executed in a security function module from an external storage section;
decrypting said encrypted secret information by applying a device key stored in said security function module;
verifying the decrypted secret information for data falsification; and
executing data processing by applying one of said program and said data included in said secret information found free of data falsification.

10. The information processing method according to claim 9, further comprising the step of:
storing said secret information including one of a program and data to be applied to data processing to be executed in said security function module into said external storage section as data encrypted with said device key.

11. The information processing method according to claim 9, further comprising the step of:
setting a falsification verification value to said secret information including one of a program and data to be applied to data processing to be executed in said security function module and storing said secret information into said external storage section.

12. The information processing method according to claim 9, further comprising the step of:
decrypting a boot code obtained from said external storage section and executing boot processing on the basis of the encrypted boot code obtained by decrypting.

13. A computer program for executing information processing, comprising the steps of:
obtaining encrypted secret information including one of a program and data to be applied to data processing to be executed in a security function module from an external storage section;
decrypting said encrypted secret information by applying a device key stored in said security function module;
verifying the decrypted secret information for data falsification; and
executing data processing by applying one of said program and said data included in said secret information found free of data falsification.
